(19) United States
(12) Patent Application Publication
(10) Pub. No.: US 2021/0011135 A1
(43) Pub. Date: Jan. 14, 2021

(54) METHOD FOR DETECTION OF LASER REFLECTORS FOR MOBILE ROBOT LOCALIZATION AND APPARATUS FOR THE SAME

(71) Applicant: ELECTRONICS AND TELECOMMUNICATIONS RESEARCH INSTITUTE, Daejeon (KR)

(72) Inventors: Yu-Cheol LEE, Daejeon (KR); Won-Pil YU, Ulsan (KR)

(21) Appl. No.: 16/918,736

(22) Filed: Jul. 1, 2020

(30) Foreign Application Priority Data
Jul. 11, 2019 (KR) 10-2019-0083711
May 26, 2020 (KR) 10-2020-0063100

(51) Int. Cl. G01S 7/481; G01S 17/931; G05D 1/02

(52) U.S. Cl. CPC G01S 7/4817; G05D 1/0259; G01S 17/931

(57) ABSTRACT

Disclosed herein is a method for detecting laser reflectors for mobile robot localization. The method includes collecting scan information data corresponding to positions of surrounding objects using a laser scanner mounted on a mobile robot; generating a reflector cluster based on reflection intensities of the scan information data; classifying the reflector cluster into individual reflector clusters, each of the individual reflector clusters corresponding to each of the laser reflectors; determining whether each of the individual reflector clusters is a valid individual reflector cluster corresponding to an actual individual laser reflector or not based on geometric filtering on die each of the individual reflector clusters; and calculating position of the actual individual laser reflector based on at least one of the scan information data corresponding to the valid individual reflector cluster.

### CROSS REFERENCE TO RELATED APPLICATION

This application claims the benefit of Korean Patent Nos. 10-2019-0083711, filed Jul. 11, 2019 and 10-2020-0063100, filed May 26, 2020, which are hereby incorporated by references in their entireties into this application.

### BACKGROUND OF THE INVENTION

### 1. Technical Field

The present invention relates to a method for detecting laser reflectors for mobile robot localization in the dynamic environment and an apparatus for the same.

### 2. Description of the Related Art

With the recent development of self-driving technologies, mobile robots are being used in various places ranging from public places to dangerous environments, such as hospitals, nuclear power plants, factories and warehouses. However, accurate location recognition (localization) technology must be preceded to operate and apply reliably autonomous driving technology to more diverse real-life situations.

Previous academic research focused on developing localization technology with natural markets from the space where robots are used. However, there is a limit in terms of stability of the technology to apply a natural marker-based localization technology developed in academic research in the dynamic environment required by the real industrial domain. Therefore, an artificial marker-based localization technology has been developed that can meet the demand for autonomous navigation technology for the actual dynamic environment and reliably drive the robot under any circumstances.

Artificial markers for localization of mobile robots, which have recently been widely used, include barcodes or RFID tags attached to the floor or walls, specially-designed markers attached to the ceiling, and laser reflectors installed on walls or columns.

Among the artificial marker-based localization method, the method of attaching barcodes or RFID tags to the floor or walls can be recognized accurately at low cost, but it is difficult to maintain due to damage caused by physical contact with surrounding users and robots Moreover, the cost of installing barcodes or RFID tags increased significantly as die range of robot applications expands. Also, the method of specially-designed markers on die ceiling may be difficult to attach depending on the structure of the ceiling, and may require separate device to detect the special markers.

However, the method of localization using laser reflector has the advantage of being able to recognize location in an area of tens of square meters with just a few reflectors, with less risk of contact damage. In addition, the laser scanner, which is used to recognize laser reflectors, is basically equipped with a moving robot for safety purposes such as obstacle avoidance, so localization can be implemented at a relatively low cost without a separate dedicated sensor for localization.

In order to implement die positioning technology of mobile robots using laser reflectors, it is essential that the position of the reflector is correctly recognized. Usually, reflectors use very high reflectivity materials for laser beams. However, the conventional method of detecting the laser reflector, which is a method of detecting the laser reflector which having the intensity of the reflection obtained from the laser scanner is above a certain boundary value, is highly likely to detect falsely the position of the reflector depending on the material of the surrounding environment. For example, materials such as glass, steel, white walls, etc. have very high laser reflectivity, so it is difficult to accurately distinguish only laser reflectors by setting the boundary values.

Accordingly, technology is required to detect the position of the laser reflector with laser scanners only, but to recognize the correct position by reducing the probability of false detection of the position of the laser reflector, even in environments composed of various materials.

### Documents of Related Art

(Patent Document 1) Korean Patent No. 10-1466953. published on Nov. 24, 2014.

### SUMMARY OF THE INVENTION

An object of the present invention is to provide a method for detecting the position of the laser reflectors which is attached for localization of the mobile robots and an apparatus for the same.

Another object of the present invention is to effectively utilize the information regarding the distance and the reflection values obtained from the laser scanner, and the geometry of predefined reflectors, and to provide a method and an apparatus for accurately detecting only the actual reflector from a variety of objects made up of materials similar to the laser reflector.

A method for detecting laser reflectors for mobile robot localization according to an embodiment includes collecting scan information data corresponding to positions of surrounding objects using a laser scanner mounted on a mobile robot; generating a reflector cluster based on reflection intensities of the scan information data: classifying the reflector cluster into individual reflector clusters, each of the individual reflector clusters corresponding to each of the laser reflectors; determining whether each of the individual reflector clusters is a valid individual reflector cluster corresponding to an actual individual laser reflector or not based on geometric filtering on the each of the individual reflector clusters; and calculating position of the actual individual laser reflector based on at least one of the scan information data corresponding to the valid individual reflector cluster.

Here, the scan information datum may include a distance to the surrounding object, an angle of a laser beam and a reflection intensity of the laser beam.

Here, the reflector cluster may correspond to the scan information data having the reflection intensities which are bigger than or equal to a reflection intensity threshold, and the reflection intensity threshold is determined according to a type of one of the laser reflectors.

Here, each of the individual reflector clusters may correspond to the scan information data having the distances whose difference is less than or equal to a distance threshold, and the distance threshold is any one of width, height, or diameter of one of the laser reflectors.

Here, the determining whether each of the individual reflector clusters is a valid individual reflector cluster may include calculating an angular range of the laser beams corresponding to each of the individual reflector clusters based on an average value of the distances of the scan information data corresponding to each of the individual reflector clusters; calculating an expected number of the scan information data included in each of the individual reflector clusters based on the angular range of the laser beams; and determining whether each of the individual reflector clusters is a valid individual reflector cluster based on the expected number of the scan information data.

Here, the angular range (Δ) of the laser beams may be determined by the equation

$$Δ = 2 {sin}^{- 1} \frac{D}{2 {d}_{m}} ,$$

where D is a width or a diameter of the laser reflector, dₘ is the average value of distances.

Here, the expected number of the scan information data may be determined by dividing the angular range of the laser beam by an angle resolution of the laser beam.

Here, the determining whether each of the individual reflector clusters is a valid individual reflector cluster may further include calculating a difference between tire expected number of the scan information data and a number of the scan information data included in each of the individual reflector clusters; and determining the individual reflector cluster as the valid individual reflector cluster if the difference is within an acceptable error number threshold.

Here, the position of the actual individual laser reflector may be calculated based on the distance and the angle of the laser beam of at least one of the scan information data corresponding to the each of the valid individual reflector clusters.

Here, the position of the actual individual laser reflector may be calculated in consideration of a radius of the actual individual laser reflector, when the actual individual laser reflector is circular.

Also, an apparatus for collecting position information of laser reflectors for mobile robot localization according to an embodiment may include a processor for collecting scan information data corresponding to positions of surrounding objects using a laser scanner mounted on a mobile robot, generating a reflector cluster based on reflection intensities of the scan information data, classifying the reflector cluster into individual reflector clusters, each of the individual reflector clusters corresponding to each of the laser reflectors, determining whether each of the individual reflector clusters is a valid individual reflector cluster corresponding to an actual individual laser reflector or not based on geometric filtering on the each of the individual reflector clusters; and memory for storing at least one of the scan information datum, the reflector cluster, the individual reflector clusters and the valid individual reflector clusters.

Here, the scan information datum may include a distance of a surrounding object, an angle of a laser beam and a reflection intensity of the laser beam.

Here, the reflector cluster may correspond to the scan information data having the reflection intensities which are bigger than or equal to a reflection intensity threshold, and the reflection intensity threshold is determined according to a type of one of the laser reflectors.

Here, each of the individual reflector clusters may correspond to the scan information data having the distances whose difference is less than or equal to a distance threshold, and the distance threshold is any one of width, height, or diameter of one of the laser reflectors.

Here, the processor may calculate an angular range of the laser beams corresponding to each of the individual reflector clusters based on an average value of the distances of the scan information data corresponding to each of the individual reflector clusters, calculate an expected number of the scan information data included in each of the individual reflector clusters based on the angular range of the laser beams, and determine whether each of the individual reflector clusters is a valid individual reflector cluster based on die expected number of the scan information data.

Here, the angular range (Δ) of the laser beams may be determined by the equation

$$Δ = 2 {sin}^{- 1} \frac{D}{2 {d}_{m}} ,$$

where D is a width or a diameter of the laser reflector, dₘ is the average value of distances.

Here, the expected number of the scan information data may be determined by dividing the angular range of the laser beam by an angle resolution of the laser beam.

Here, the processor may calculate a difference between the expected number of the scan information data and a number of the scan information data included in each of the individual reflector clusters, and determine the individual reflector cluster as the valid individual reflector cluster if the difference is within an acceptable error number threshold.

Also, an apparatus for calculating positions of laser reflectors for mobile robot localization according to an embodiment may include a processor for receiving valid individual reflector clusters corresponding to actual individual laser reflectors from a position information collection apparatus, and calculating position of the actual individual laser reflector based on at least one of the scan information data corresponding to the each of the valid individual reflector clusters; and memory for storing the positions of the actual individual laser reflectors.

Here, the position of the actual individual laser reflector may be calculated based on the distance and the angle of the laser beam of at least one of the scan information data corresponding to die each of the valid individual reflector clusters.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a view illustrating an environment in which a system for detecting laser reflectors for mobile robot localization according to an embodiment is used.

FIG. 2 is a block diagram illustrating an example of the system for detecting laser reflectors for mobile robot localization.

FIG. 3 is a view illustrating an example of the apparatus for collecting position information illustrated in FIG. 2;

FIG. 4 is a view illustrating an example of the position information corresponding to the environment illustrated in FIG. 1. collected by the apparatus for collecting position information in FIG.2;

FIGS. 5A and 5B are views illustrating examples for the apparatus for calculating positions illustrated in FIG.2 to calculate position of the actual individual laser reflector based on at least one of the scan information data corresponding to the valid individual reflector cluster;

FIG. 6 is a view illustrating a flowchart for the method for detecting laser reflectors for mobile robot localization; and

FIG. 7 is a view illustrating the configuration of a computer system according to an embodiment.

### DESCRIPTION OF THE PREFERRED EMBODIMENTS

The advantages and features of the present invention and methods of achieving them will be apparent from the following exemplary embodiments to be described in more detail with reference to the accompanying drawings. However, it should be noted that the present invention is not limited to the following exemplary embodiments, and may be implemented in various forms. Accordingly, tire exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the teachings of the present invention.

The terms used herein are for the purpose of describing particular embodiments only and are not intended to limit the present invention. As used herein, the singular forms arc intended to include the plural forms as well, unless the context clearly indicates otherwise. It will be further understood that the terms “comprises,” “comprising”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

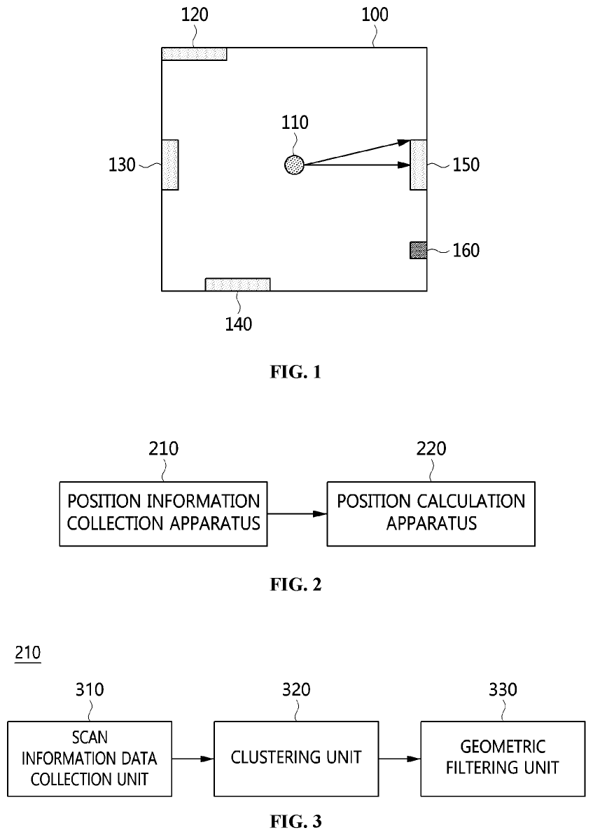

Hereinafter, a method for detecting laser reflectors for mobile robot localization and an apparatus for the same according to an embodiment will be described in detail with reference to FIGS. 1 to 7.

FIG. 1 is a view illustrating an environment in which a system for detecting laser reflectors for mobile robot localization according to an embodiment is used.

For the convenience of explanation. FIG. 1 assumes that the environment in which the laser reflector position recognition system is used is surrounded by square walls 100. FIG. 1 shows the environment looking down from the top, in which a laser scanner 110 mounted on a mobile robot scanning the squall walls.

Referring to FIG. 1. the mobile robot uses a laser scanner 110 mounted on the mobile robot to recognize the position of the laser reflector 120, 130, 140 and 150 installed on each side of the square walls. However, the environment may contain not only laser reflectors but also a highly reflective confusing object 160 that causes false detection of the reflector. In real environment, the laser reflector for localization of the moving robot can be installed similarly or differently from FIG. 1. For the convenience of explanation, the following assumes and explains that reflectors are attached as shown in FIG. 1.

Conventional technology for detecting the laser reflectors is to detect the laser reflector, which reflection intensity is above a certain threshold value, using the laser scanner. Thus, if the reflectivity of the confusing object 160 is equal to or greater than that of the reflector, the confusing object is also detected as a laser reflector. After all, setting this threshold value alone makes it difficult to distinguish only laser reflectors 120,130, 140 and 150 precisely.

As illustrated in FIG. 1, the confusing object 160 may differ in geometric information, such as a width, from the actual reflector. Also, because the reflectors are usually installed by the user, the geometric information including the size of the reflector may be available by the user. Thus, by using this geometric information of the reflectors, a method for detecting laser reflectors for mobile robot localization according to an embodiment can remove only the confusing object 160. The method of elimination of the confusing object 160 using the geometric information is named as a geometric filtering method. The specific behavior of the method for detecting laser reflectors is described in detail in the following figures.

FIG. 2 is a block diagram illustrating an example of the system for detecting laser reflectors for mobile robot localization.

Referring to FIG. 2, the system for detecting laser reflectors for mobile robot localization may include a position information collection apparatus 210 and a position calculation apparatus 220.

The position information collection apparatus 210 may collect scan information data corresponding to positions of surrounding objects using a laser scanner mounted on a mobile robot. The apparatus 210 may generate a reflector cluster based on reflection intensities of the scan information data. The apparatus 210 may classify the reflector cluster into individual reflector clusters, each of the individual reflector clusters corresponding to each of the laser reflectors. And the apparatus 210 may determine whether each of the individual reflector clusters is a valid individual reflector cluster corresponding to an actual individual laser reflector or not based on geometric filtering on the each of the individual reflector clusters.

Here, the scan information datum includes a distance to the surrounding object, an angle of a laser beam and a reflection intensity of the laser beam. The reflector cluster and tire individual reflector cluster, and the valid individual reflector are sets of scan information data respectively.

First of all, to recognize the position of the laser reflector, a laser scanner should be used to measure not only distance information but also reflection intensity (or received signal strength) information. The laser scanner shall then be able to measure the distance to the nearest (surrounding) object in the direction in which the beam is directed and also the reflection intensity information obtained at that time. Zₜ measured by the laser scanner at any time t consists of N scan information data, can be represented as shown in Equation (1):

Zₜ={zᵢ|i=1, . . . , N}, zᵢ=(dᵢ, θᵢrᵢ) (1)

In Equation (1), zᵢ is the i-th scan information datum of die laser scanner, and the scan information datum consists of angle θᵢ of the laser beam, distance dᵢ of the nearest object in the direction of the laser beam, and reflection intensity n of the laser beam.

Also, the position information collection apparatus 210 may generate a reflector cluster based on reflection intensities of the scan information data. The reflector cluster may correspond to the scan information data having the reflection intensities which are bigger than or equal to a reflection intensity threshold, and the reflection intensity threshold is determined according to a type of one of the laser reflectors.

Since the actual reflector is made with a good reflectance of the laser beam, the reflection intensity obtained by the reflector is higher than that of the surrounding object. So if the reflection intensity is above a threshold value, it is likely to be the scan information datum obtained from the actual reflector. Thus, in this invention, in order to obtain only scan information datum for real reflectors, only scan information datum with reflection intensity above a certain boundary value can be filtered and stored as a reflector cluster S, which can be represented as Equation (2):

S={zᵢ|rᵢ>rₜₕᵣₑₛₕ} (2)

In Equation (2), rᵢ means a reflection intensity of the i-th scan information datum, and rₜₕᵣₑₛₕ means a threshold value of the reflection intensity. The threshold value of rite reflection intensity can be determined by measurement analysis using the actual laser scanner and reflector used for robot localization, since the values may vary depending on the type of laser scanner and reflector used. This filtered set of scan information data is represented as reflector cluster S. And then the reflector cluster may be clustered into the individual reflector clusters corresponding to the scan information data obtained from the individual reflectors.

Also, the position information collection apparatus 210 may classify the reflector cluster into individual reflector clusters. Each of the individual reflector clusters corresponds to the scan information data having the distances whose difference is less than or equal to a distance threshold, and the distance threshold is any one of width, height, or diameter of one of the laser reflectors.

In order to cluster the scan information data of the reflector cluster into the scan information data of the individual reflector cluster, the actual size information of the used reflectors can be utilized and the individual reflector clusters may be represented as in Equation (3):

$$C = \{ \begin{matrix}{m}_{j} ← {z}_{i} , \vert {d}_{i + 1} - {d}_{i} \vert < {d}_{thresh} \\ {m}_{j + 1} ← {z}_{i} , otherwise \end{matrix} \\ {m}_{j} = \{ {z}_{i} \vert i = 1 , … , M \} \qquad ( 3 )$$

In Equation (3), mⱼ and mⱼ₊₁ mean j-th and j+1-th individual reflector cluster respectively, and mⱼ consists of M scan information data. And dₜₕᵣₑₛₕ is a distance threshold value.

That is, for two consecutive scan information data zᵢ and zᵢ₊₁ to be included in the same individual reflector cluster, the difference in distance between the two-scan information data must be within the distance threshold, dₜₕᵣₑₛₕ. In addition, usually one individual reflector cluster is a collection of scan information data for a single reflector, and the distance threshold (dₜₕᵣₑₛₕ) can be any one of width, height, or diameter of the single reflector.

As above, the mⱼ and mⱼ₊₁ obtained through clustering method are individual reflector clusters expected to have scan information data obtained from the different reflectors. And the individual reflector clusters will be performed geometric filtering to determine whether the scan information data of the individual reflector clusters satisfies the geometry information of the actual reflector.

Also, the position information collection apparatus 210 may determine whether each of the individual reflector clusters is a valid individual reflector cluster corresponding to an actual individual laser reflector or not based on geometric filtering on the each of the individual reflector clusters. To do so, the apparatus 210 may calculate an angular range of the laser beams corresponding to each of the individual reflector clusters based on an average value of the distances of the scan information data corresponding to each of the individual reflector clusters, calculate an expected number of the scan information data included in each of the individual reflector clusters based on the angular range of the laser beams, and determine whether each of the individual reflector clusters is a valid individual reflector cluster based on the expected number of the scan information data.

Here, the angular range (Δ) of the laser beams may be determined by the equation,

$$Δ = 2 {sin}^{- 1} \frac{D}{2 {d}_{m}} ,$$

where D is a width or a diameter of the laser reflector, dₘ is the average value of distances. Also, the expected number of the scan information data may be determined by dividing the angular range of the laser beam by an angle resolution of the laser beam.

Also, in order to determine whether each of the individual reflector clusters is a valid individual reflector cluster, the position information collection apparatus 210 may calculate a difference between the expected number of the scan information data and a number of the scan information data included in each of the individual reflector clusters, and determine the individual reflector cluster as the valid individual reflector cluster if the difference is within an acceptable error number threshold.

The geometric filtering method uses the physical size information of the actual reflector to determine whether a cluster is a collection of scan information data obtained from the actual reflector. The method for performing the geometric filtering can be represented in Equation (4) and Equation (5):

$${\overline{d}}_{j} = \frac{1}{M} {\sum }_{i = 1}^{M} {d}_{i} , {\overline{θ}}_{j} = \frac{{θ}_{M} - {θ}_{1}}{2} , {\overline{r}}_{j} = \frac{1}{M} {\sum }_{i = 1}^{M} {r}_{i} \qquad ( 4 )$$

In Equation (4), d̅ⱼ, θ̅ⱼ, \ddot{r}ⱼ are an average distance, a median angle, an average reflection intensity of the scan information data of the j-th individual reflector cluster respectively.

The number of the scan information data included in the cluster may vary depending on the average distance d̅ⱼ of the individual reflector cluster. That is, the smaller the average distance value d̅ⱼ of a cluster, the greater the number of the scan information data in one cluster. The used laser reflector may be flat or circular. If the horizontal (or vertical) size of the flat reflector or the diameter of the circular reflector is D. the angular range of can be represented in Equation (5):

$${Δ}_{j} = 2 {sin}^{- 1} \frac{D}{2 {\overline{d}}_{j}} , {M}^{⋒} \approx \frac{{Δ}_{j}}{δ} \qquad ( 5 )$$

In Equation (5), Δⱼ an angular range of the laser beam in the individual reflector cluster, δ is an angular resolution of the laser beam, \hat{M} is an expected number of the scan information data corresponding to the individual reflector cluster. Therefore, the angular range Δⱼ of the laser beams in the individual reflector cluster is calculated based on the horizontal length D of the installed reflector and the average distance value d̅ⱼ of the scan information data in the individual reflector cluster. And the expected number \hat{M} can be calculated by dividing the angular range of the laser beam by the angular resolution δ of the laser beam. If the expected number is similar to M, which is the number of scan information data of the individual reflector cluster, it is highly likely that the individual reflector cluster will be the actual individual reflector. The degree to those two numbers should be similar can be determined by an acceptable error number. The key to the geometric filtering method is to compare the expected number and tire actual number to determine whether it is a valid individual reflector cluster corresponding to an actual laser reflector.

And then, the position calculation apparatus 220 may calculate position of the actual individual laser reflector based on at least one of the scan information data corresponding to the valid individual reflector cluster, generated in the position information collection apparatus 210.

The position calculation apparatus 220 may calculate the position of the actual individual laser reflector based on the distance and the angle of the laser beam of at least one of the scan information data corresponding to the each of the valid individual reflector clusters. Here, the position of the actual individual laser reflector may be calculated in consideration of a radius of the actual individual laser reflector, when the actual individual laser reflector is circular.

That is, an individual reflector cluster meeting the conditions of the geometric filtering method can be determined as a valid individual reflector cluster, which is a cluster of the scan information data to the actual reflector. And the scan information data of the valid individual reflector cluster can be used to calculate the position of the actual reflector. The coordinate (xⱼ, yⱼ) on the orthogonal coordinates of the j-th individual reflector cluster determined to be a valid individual reflector cluster can be calculated as shown in Equation (6), if the installed reflector is circular. In addition, the coordinate (xⱼ, yⱼ) can be calculated as shown in Equation (7), if the installed reflector is flat. The difference between the two equations is that if the reflector is circular, the radius D/2 of the circular reflector should be further taken into account when calculating the position of the actual reflector:

$$\begin{matrix}[ \begin{matrix}{x}_{j} \\ {y}_{j}\end{matrix} ] = ( {\overline{d}}_{j} + \frac{D}{2} ) [ \begin{matrix}cos {\overline{θ}}_{j} \\ sin {\overline{θ}}_{j}\end{matrix} ] & ( 6 ) \\ [ \begin{matrix}{x}_{j} \\ {y}_{j}\end{matrix} ] = ( {\overline{d}}_{j} ) [ \begin{matrix}cos {\overline{θ}}_{j} \\ sin {\overline{θ}}_{j}\end{matrix} ] & ( 7 )\end{matrix}$$

In Equations (6) and (7), d̅ⱼ, θ̅ⱼ are an average distance, a median angle respectively of the scan information data included in the j*th individual reflector cluster, D is a size of the diameter of a circular reflector or the length of a flat reflector. In this way, the actual position of the reflector is detected, and the position of the reflector is later used by the mobile robot to recognize its position.

FIG. 3 is a view illustrating an example of the apparatus for collecting position information illustrated in FIG. 2.

Referring to FIG. 3. the apparatus for collecting position information 210 may include a scan information datum collection unit 310, a clustering unit 320. and a geometric filtering unit 330.

The scan information datum collection unit 310 may gather scan information data corresponding to positions of surrounding objects using a laser scanner mounted on a mobile robot. The clustering unit 320 may generate a reflector cluster based on reflection intensities of the scan information data, and classify the reflector cluster into individual reflector clusters, each of the individual reflector clusters corresponding to each of the laser reflectors. The geometric filtering unit 330 may determine whether each of the individual reflector clusters is a valid individual reflector cluster corresponding to an actual individual laser reflector or not based on geometric filtering on the each of the individual reflector clusters. Here, the scan information datum may include a distance to the surrounding object, an angle of a laser beam and a reflection intensity of the laser beam.

First of all, to recognize the position of the laser reflector, a laser scanner which can measure not only distance information but also reflection intensity (or received signal strength) information is used. The laser scanner shall then be able to measure the distance to the nearest object in the direction in which the beam is directed and the reflection intensity information obtained at that time. Zₜ, measured by the laser scanner at any time t consists of N scan information data, can be represented as shown in Equation (1). That is, the scan information data are a total of N sets of i-th scan information datum zᵢ of the laser scanner, which is consisting of angle θᵢ of the laser beam, distance dᵢ of the nearest object in the direction of the laser beam, and reflection intensity n of the laser beam.

The behavior of the position information collection apparatus 210 is described in detail by an example of the environment illustrated in FIG. 1. Suppose that there is a reflector on each side of the square environment in FIG. 1. and the laser scanner scans counterclockwise from the lower right corner and acquires a total of 40 scan information data for 360 degrees. If so, N is 40, and the angle resolution of the laser beam is approximately π/20(=π/2/10). So, 40 scan information data from z1 to z40 may be collected by the scan information data collection unit 310, and the collected scan information data can be shown in Table 1:

TABLE 1
N scan information data

| | | | | | | | | | |
|---|---|---|---|---|---|---|---|---|---|
| Z1 | Z2 | Z3 | Z4 | Z5 | Z6 | Z7 | Z8 | Z9 | Z10 |
| Z11 | Z12 | Z13 | Z14 | Z15 | Z16 | Z17 | Z10 | Z19 | Z20 |
| Z21 | Z22 | Z23 | Z24 | Z25 | Z26 | Z27 | Z28 | Z29 | Z30 |
| Z31 | Z32 | Z33 | Z34 | Z35 | Z36 | Z37 | Z38 | Z39 | Z40 |

The clustering unit 320 may generate a reflector cluster based on reflection intensities n of the scan information data, and the reflector cluster may correspond to the scan information data having the reflection intensities which are bigger than or equal to a reflection intensity threshold, and the distance threshold is any one of width, height, or diameter of one of the laser reflectors. That is, the threshold value of the reflection intensity can be determined by measurement analysis of the actual laser scanner and reflector used for robot localization, since the threshold value may vary depending on the type of laser scanner and reflector used.

Since the actual reflector is made with a good reflectance of the laser beam, the reflection intensity obtained by the reflector is higher than that of the surrounding object. So if the reflection intensity is above a threshold value, it is likely to be the scan information datum obtained from the actual reflector. Thus, in the example environment illustrated in FIG. I, the clustering unit 320 first may select only scan information data with reflection intensity above a certain threshold value using Equation (2) and store it as a reflector cluster S as shown in Table 2:

TABLE 2
A reflector cluster S

| | | | | | | | | | |
|---|---|---|---|---|---|---|---|---|---|
| Z1 | Z2 | | Z4 | Z5 | Z6 | Z7 | | | |
| | | | | | | Z17 | Z18 | Z19 | Z20 |
| | | | Z24 | Z25 | Z26 | Z27 | | | |
| | Z32 | Z33 | Z34 | Z35 | | | | | |

Also, the clustering unit 320 may store the scan information data having the distances whose difference is less than or equal to a distance threshold in one individual reflector cluster to classify the reflector cluster into individual reflector clusters corresponding to tire positions of the individual reflectors, and the distance threshold is any one of width, height, or diameter of one of the laser reflectors.

In order to classify the scan information data of the reflector cluster into the scan information data of the individual reflector cluster, the actual size information of the used reflectors can be utilized, and the individual reflector clusters can be represented in Equation (3). That is, for two consecutive scan information data zᵢ and zᵢ₊₁ to be included in the same individual reflector cluster, the difference in distance between the two scan information data must be within the distance threshold, dₜₕᵣₑₛₕ, which can be any one of width, height, or diameter of the reflector.

The mⱼ and mⱼ₊₁ obtained through the previously described clustering method are individual reflector clusters expected to have scan information data obtained from the different reflectors. And the individual reflector clusters will be filtered geometrically to determine whether the scan information data of the individual reflector clusters satisfies the geometry information of the actual reflector. For the example environment in FIG. 1 and the reflector cluster S in Table 2, the individual reflector cluster can be selected as in Table 3:

TABLE 3
Individual reflector clusters

| | | | | | | | | | |
|---|---|---|---|---|---|---|---|---|---|
| Z1 | Z2 | | Z4 | Z5 | Z6 | Z7 | | | |
| (m5) | (m5) | | (m1) | (m1) | (m1) | (m1) | | | |
| | | | | | | Z17 | Z18 | Z19 | Z20 |
| | | | | | | (m2) | (m2) | (m2) | (m2) |
| | | | Z24 | Z25 | Z26 | Z27 | | | |
| | | | (m3) | (m3) | (m3) | (m3) | | | |
| | Z32 | Z33 | Z34 | Z35 | | | | | |
| | (m4) | (m4) | (m4) | (m4) | | | | | |

In Table 3, parentheses refer to the each of the individual reflector clusters to which the scan information data belong, and there are 5 individual reflector clusters, m1, m2, m3, m4 and m5, generated in this example.

The geometric filtering unit 330 may calculate an angular range of the laser beams corresponding to each of the individual reflector clusters based on an average value of the distances of the scan information data corresponding to each of the individual reflector clusters, calculate an expected number of the scan information data included in each of the individual reflector clusters based on the angular range of the laser beams, and determine whether each of the individual reflector clusters is a valid individual reflector cluster based on the expected number of the scan information data, to determine whether each of the individual reflector clusters is a valid individual reflector cluster.

Here, the angular range (Δ) of the laser beams may be determined by the equation.

$$Δ = 2 {sin}^{- 1} \frac{D}{2 {d}_{m}} ,$$

where D is a width or a diameter of the laser reflector, dₘ is the average value of distances. And the expected number of the scan information data may be determined by dividing the angular range of the laser beam by an angle resolution of the laser beam.

Also, the geometric filtering unit 330 may calculate a difference between the expected number of the scan information data and a number of the scan information data included in each of the individual reflector clusters, and determine the individual reflector cluster as the valid individual reflector cluster if the difference is within an acceptable error number threshold to determine whether each of the individual reflector cluster is a valid individual reflector cluster.

The geometric filtering unit 330 may use the geometric filtering method, using the physical size information of the actual reflector to determine whether a cluster is a collection of scan information data obtained from the actual reflector. The geometric filtering method can be represented in Equation (4) and Equation (5). The used laser reflector may be flat or circular. If the horizontal (or vertical) size of the flat reflector or the diameter of the circular reflector is D, the number of the scan information data included in the cluster may vary depending on the average distance d̅ⱼ of the individual reflector cluster. That is, the smaller the average distance d̅ⱼ of a cluster, the greater the number of the scan information data in one cluster. This can be represented in Equation (5).

Therefore, the angular range of the laser beams in the individual reflector cluster may be calculated based on the horizontal length or the diameter D of the installed reflector and the average distance value d̅ⱼ of the scan information data in the individual reflector cluster. And the expected number \hat{M} can be calculated by dividing the angular range of the laser beam by the angular resolution δ of the laser beam. The expected number needs to be similar to the number of scan information data of the individual reflector cluster. In the example of the FIG. 1, the valid individual reflector clusters can be selected from the individual reflector dusters in Table 3 by the geometric filtering unit 330 as shown in Table 4:

TABLE 4
Valid individual reflector clusters

| | | | | | | | | |
|---|---|---|---|---|---|---|---|---|
| | | Z4 | Z5 | Z6 | Z7 | | | |
| | | (m1) | (m1) | (m1) | (m1) | | | |
| | | | | | Z17 | Z18 | Z19 | Z20 |
| | | | | | (m2) | (m2 | (m2) | (m2) |
| | | Z24 | Z25 | Z26 | Z27 | | | |
| | | (m3) | (m3) | (m3) | (m3) | | | |
| Z32 | Z33 | Z34 | Z35 | | | | | |
| (m4) | (m4) | (m4) | (m4) | | | | | |

In Table 4, only m1, m2, m3 and m4 are selected as valid individual reflector clusters from 5 individual reflector clusters in Table 3. In Table 3, the number of the scan information data of the m1, m2, m3 and m4 is 4, while the number of the scan information data of m5 is 2. Since the angular range of the laser beam of each individual reflector cluster may be approximately π/5, the expected number of the scan information data may be 4, which dividing the angular range by the angle resolution it π/20. Thus, only m1, m2, m3 and m4 can be selected as valid individual reflector clusters, having die same number of scan information data as the expected number and m5 can be removed.

The above example shows a relatively simple calculating process with only 40 scan information data acquired at a point in time for simple explanation of the behavior of this invention. So, the number of scan information data can be varied according to the user, the laser scanner and the environment in which it is used. In particular, a cumulative collection of scan information data over the time period may be used to collect, cluster, and filter geometrically to obtain more accurate calculation of the position of the laser reflectors.

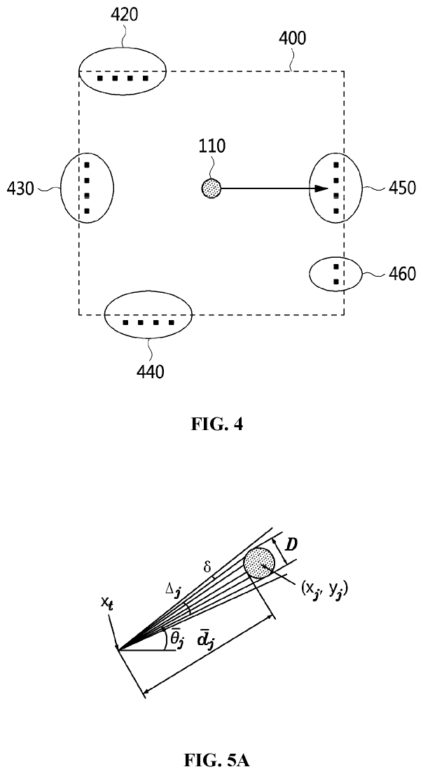

FIG. 4 is a view illustrating an example of the position information corresponding to the environment illustrated in FIG. 1, collected by the apparatus for collecting position information in FIG. 2.

Referring to FIG. 4, the process of scanning information data being clustered into the reflector cluster, individual reflector clusters and valid individual reflector clusters using geometric filtering method is described.

In FIG. 4. the scan information data, including distance, angle, and reflection intensity obtained by the actual laser scanner 110, is expressed in a combination of dots (points). The square-shaped set of points 400 in FIG 4, indicate the positions of the surrounding objects, and each point is illustrated on a Cartesian coordinate system using the distance and the angle of the scan information datum. And the areas 420, 430, 440. 450, 460 marked with thicker dots next to the points 400 mean that the intensity of the reflection at the locations of those thicker dots is bigger than or equal to a reflection intensity threshold.

Referring to FIG. 4, it can be seen that the environment surrounded by square walls illustrated in FIG. 1 is detected as a collection of points.

First, the scan information collection unit of the position information collection apparatus scans the walls using a laser scanner mounted on a mobile robot to collect scan information data corresponding to the positions of surrounding objects. The scan information data may include a distance to the surrounding object, an angle of a laser beam and a reflection intensity of the laser beam. The scan information collection unit may collect the positions 400 of the square wall of the surrounding object, and detect the areas 420, 430, 440, 450, 460 in which the reflection intensity of the positions exceeds the threshold.

And then, the clustering unit of the position information collection apparatus may store the scan information data as a reflector cluster corresponding to the scan information data having the reflections intensities which are bigger than or equal to a reflection intensity threshold, the threshold may be determined by the type of laser reflector. Thus, the clustering unit may store all the area 420, 430, 440, 450, 460 as a reflector cluster in which reflection intensities of the scan information data exceeds the reflection intensity threshold.

Also, the clustering unit of the position information collection apparatus may classify the reflector cluster including the area 420, 430, 440, 450, 460 into 5 different individual reflector clusters. To do so, the clustering unit may store the scan information data in the same individual reflector cluster, if the scan information data having the distances whose difference is within a distance threshold. In FIG. 4, the reflector cluster is classified into the individual reflector clusters, m1 420, m2 430, m3 440, m4 450, and m5 460.

After generation of the individual reflector clusters, the geometric filtering unit of the position information collection apparatus may calculate an angular range of the laser beams corresponding to each of the individual reflector clusters based on an average value of the distances of the scan information data corresponding to each of the individual reflector clusters, calculate an expected number of the scan information data included in each of the individual reflector clusters based on the angular range of the laser beams: and determine whether each of the individual reflector clusters is a valid individual reflector cluster based on the expected number of the scan information data.

In FIG. 4, by counting the number of points, we know that the number of scan information data of m1 420, m2 430, m3 440, m4 450 is 4, and that of m5 460 is 2. Since die geometrical information of the reflector is known, the geometric filtering unit can calculate the angular range of the laser beam by

$$2 {sin}^{- 1} \frac{D}{2 {d}_{m}} ,$$

and calculate an expected number of the scan information datum based on the calculated angular range. And we can see that the expected number would be similar to 4 in the FIG. 4. Therefore, only m1 420, m2 430, m3 440, m4 450 with similar or equal values to the expected number can be selected as valid individual reflector clusters.

Finally, the valid individual reflector clusters which is clustered by the position information collection apparatus from the scan information data are m1 420, m2 430, m3 440, m4 450, which is consistent with the information of the environment illustrated in FIG. 1. And the position calculation apparatus accurately recognizes the position of the actual individual reflectors based on the valid individual reflector clusters later.

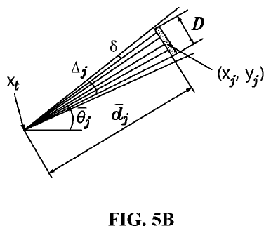

FIGS. 5A and 5B are views illustrating examples for the apparatus for calculating positions illustrated in FIG. 2 to calculate position of the actual individual laser reflector based on at least one of the scan information data corresponding to the valid individual reflector cluster.

The position calculation apparatus may calculate position of the actual individual laser reflector based on at least one of the scan information data corresponding to the valid individual reflector cluster, generated in the position information collection apparatus.

The position calculation apparatus may calculate the position of the actual individual laser reflector based on the distance and the angle of the laser beam of at least one of the scan information data corresponding to the each of the valid individual reflector clusters. The position of the actual individual laser reflector may be calculated in further consideration of a radius of the actual individual laser reflector, when the actual individual laser reflector is circular.

An individual reflector cluster meeting the conditions of the geometric filtering method can be determined as a valid individual reflector cluster, and the scan information data of the valid individual reflector cluster can be used to calculate the position of the actual reflector.

FIG. 5A shows how to calculate the location (xⱼ, yⱼ) of the Cartesian coordinates of the j-th individual reflector cluster determined as the valid individual reflector cluster when the installed reflector is circular, using the equation (6). That is. the location of the actual individual reflector can be calculated based on an average distance d̅ⱼ and a median angle θ̅ⱼ of the scan information data included in the j-th individual reflector cluster.

FIG. 5B shows tire calculation of the location of the Cartesian coordinates of the j-th individual reflector cluster determined as the valid individual reflector cluster when the installed reflector is flat, using the equation (7).

As can be seen in FIGS. 5A and 5B, if the reflector is circular, the average distance d̅ⱼ is less than the actual position (xⱼ, yⱼ) of the reflector by the radius D/2 of the reflector, so the radius should be taken into account when calculating the position of the circular reflector.

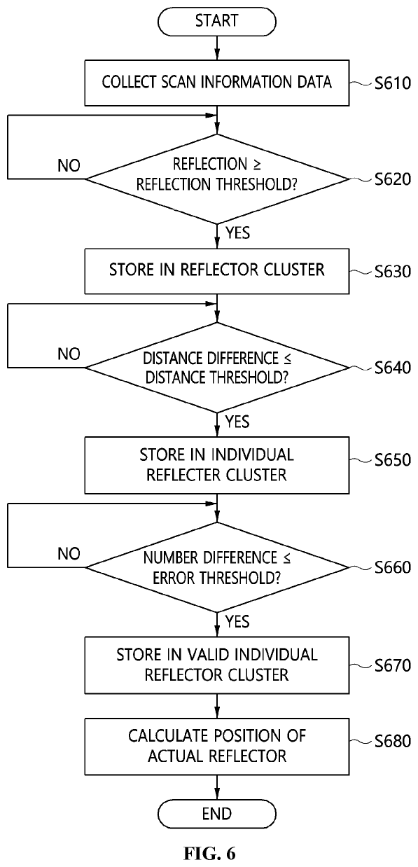

FIG. 6 is a view illustrating a flowchart for the method for detecting laser reflectors for mobile robot localization.

Referring to FIG. 6, the position information collection apparatus collects scan information data using a laser scanner at step S610.

The position information collection apparatus may collect scan information data corresponding to positions of surrounding objects using a laser scanner mounted on a mobile robot. The apparatus may generate a reflector cluster based on reflection intensities of the scan information data and classify the reflector cluster into individual reflector clusters, each of the individual reflector clusters corresponding to each of the laser reflectors. And the apparatus may determine whether each of the individual reflector clusters is a valid individual reflector cluster corresponding to an actual individual laser reflector or not based on geometric filtering on the each of the individual reflector clusters. Here, the scan information datum includes a distance to tire surrounding object, an angle of a laser beam and a reflection intensity of the laser beam.

And, the position information collection apparatus determines whether the reflection intensity of one scan information datum is bigger than or equal to a reflection intensity threshold or not at step S620. If the reflection intensity of the scan information datum is bigger than or equal to the reflection intensity threshold, it stores the scan information datum in a reflector cluster at step S630. But if the reflection intensity of the scan information datum is less than the reflection intensity threshold, it goes to the step S620 and determines whether the reflection intensity of the other scan information datum is bigger than or equal to tire threshold. The position information collection apparatus can generate a reflector cluster by repeating those processes for all tire scan information data.

That is, the position information collection apparatus may store the scan information data having the reflection intensities which are bigger than or equal to a reflection intensity threshold as a reflector cluster, and the distance threshold may be determined by the type of the used reflector. It is using the fact that the reflection intensity obtained by the actual reflector is higher than that of the surrounding object, since the actual reflector is made with a good reflectance of the laser beam.

And, the position information collection apparatus determines whether difference in distances of the scan information data in the reflector cluster is less than or equal to the distance threshold at step S640. If the difference in distances is less than or equal to the distance threshold, it stores the scan information data in an individual reflector cluster at step S650. But if the difference is bigger than the distance threshold, it goes to the step S640 and determines whether the difference in distances of the other scan information data is less than or equal to the threshold. The position information collection apparatus can generate individual reflector clusters by repeating those processes for all the scan information data of the reflector cluster.

That is, the position information collection apparatus may store the scan information data having the distances whose difference is less than or equal to a distance threshold as an individual reflector cluster to classify the reflector cluster into individual reflector clusters, and the distance threshold may be any one of width, height, or diameter of one of the laser reflectors. The actual size information of the actual reflectors is used to cluster the scan information data of the reflector cluster into the scan information data of the individual reflector cluster.

And, the position information collection apparatus determines whether the difference between the expected number and the number of the scan information data of one individual reflector cluster is within an acceptable error number threshold at step S660. If th difference is less than or equal to the error number threshold, it selects the individual reflector cluster as a valid individual reflector cluster at step S670. But if the difference is bigger than the error number threshold, it goes to the step S660 and determines whether the difference between the expected number and the number of the scan information data of other individual reflector cluster is within an acceptable error number threshold. The acceptable error number threshold can be determined by the user, the environment used, and the scanning accuracy of the laser scanner. And the expected number of the scan information data may be calculated based on the angular range of the laser beam and the angle resolution of die laser beam.

That is, die position information collection apparatus may calculate an angular range of die laser beams corresponding to each of the individual reflector clusters based on an average value of the distances of the scan information data corresponding to each of the individual reflector clusters, calculate an expected number of the scan information data included in each of the individual reflector clusters based on the angular range of the laser beams, and determine whether each of die individual reflector clusters is a valid individual reflector cluster based on the expected number of the scan information data to determine whether each of the individual reflector clusters is a valid individual reflector cluster.

Here, the angular range (Δ) of the laser beams may lie determined by the equation

$$Δ = 2 {sin}^{- 1} \frac{D}{2 {d}_{m}} ,$$

where D is a width or a diameter of the laser reflector, dₘ is the average value of distances And the expected number of the scan information data may be determined by dividing the angular range of the laser beam by an angle resolution of the laser beam.

Also, the position information collection apparatus may calculate a difference between the expected number of the scan information data and a number of the scan information data included in each of the individual reflector clusters, and determine the individual reflector cluster as the valid individual reflector cluster if the difference is within an acceptable error number threshold. The apparatus may use the geometric filtering method The method utilizes the physical size information of the actual reflector to determine whether a cluster is a collection of scan information data obtained from the actual reflector.

And, the position calculation apparatus calculates position of the actual individual laser reflector based on the scan information data corresponding to the valid individual reflector cluster at step S680.

That is, the position calculation apparatus may calculate the position of the actual individual laser reflector based on the distance and the angle of the laser beam of at least one of the scan information data corresponding to the each of the valid individual reflector clusters. The position of the actual individual laser reflector may be calculated in further consideration of a radius of the actual individual laser reflector, when the actual individual laser reflector is circular.

An individual reflector cluster meeting the conditions of the geometric filtering method can be determined as a valid individual reflector cluster, and the scan information data of the valid individual reflector cluster can be used to calculate die position of the actual reflector. The coordinate on the Cartensian coordinates of the j-th individual reflector cluster determined to be a valid individual reflector cluster can be calculated as shown in Equation (6) or Equation (7), if the reflector is circular or flat respectively. The difference between the two equations is that if the reflector is circular, the radius D/2 the circular reflector should be further taken into account when calculating the position of the actual reflector.

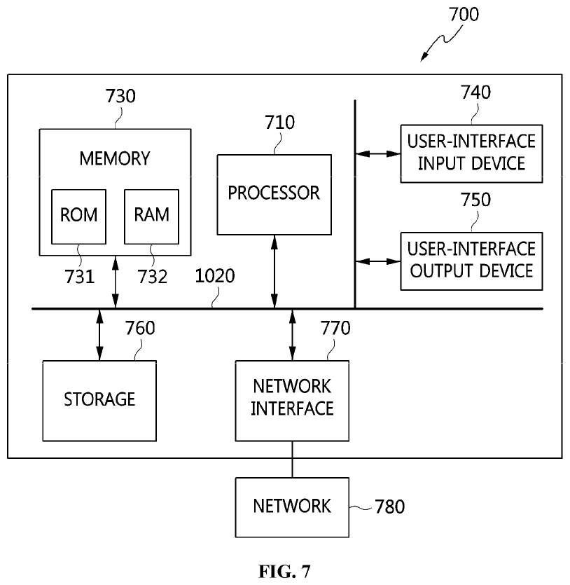

FIG. 7 is a view illustrating the configuration of a computer system according to an embodiment.

An apparatus for collecting position information of laser reflectors for mobile robot localization or an apparatus for calculating positions of laser reflectors for mobile robot localization according to an embodiment may be implemented in a computer system 700 including a computer-readable recording medium.

The computer system 700 may include one or more processors 710, memory 730, a user-interface input device 740, a user-interface output device 750, and storage 760, which communicate with each other via a bus 720. Also, the computer system 700 may further include a network interface 770 connected with a network 780. The processor 710 may be a central processing unit or a semiconductor device for executing a program or processing instructions stored in the memory 730 or the storage 760. The memory 730 and the storage 760 may be storage media including at least one of a volatile medium, a nonvolatile medium, a detachable medium, a non-detachable medium, a communication medium, and an information delivery medium. For example, the memory 730 may include ROM 731 or RAM 732.

According to the embodiment described above, the present invention may provide a method for detecting the position of the laser reflectors which is attached for localization of the mobile robots and an apparatus for the same.

Also, the present invention may effectively utilize the information regarding die distance and the reflection obtained from the laser scanner, and the geometry of predefined reflectors, and provide a method and an apparatus for accurately detecting only the actual reflector from a variety of objects made up of materials similar to the laser reflector.

Although the embodiments of the present invention have been described with reference to the accompanying drawings, those skilled in the art will appreciate that the present invention may be practiced in other specific forms without changing the technical spirit or essential features of the present invention. Therefore, the embodiments described above are illustrative in all aspects and should not be understood as limiting the present invention.

What is claimed is:

1. A method for detecting laser reflectors for mobile robot localization, comprising:
collecting scan information data corresponding to positions of surrounding objects using a laser scanner mounted on a mobile robot;
generating a reflector cluster based on reflection intensities of the scan information data;
classifying the reflector cluster into individual reflector clusters, each of the individual reflector clusters corresponding to each of the laser reflectors;
determining whether each of the individual reflector clusters is a valid individual reflector cluster corresponding to an actual individual laser reflector or not based on geometric filtering on the each of the individual reflector clusters; and
calculating position of the actual individual laser reflector based on at least one of the scan information data corresponding to the valid individual reflector cluster

2. The method of claim 1, wherein die scan information datum includes a distance to the surrounding object, an angle of a laser beam and a reflection intensity of the laser beam.

3. The method of claim 2, wherein the reflector cluster corresponds to the scan information data having the reflection intensities which are bigger than or equal to a reflection intensity threshold, and
the reflection intensity threshold is determined according to a type of one of the laser reflectors.

4. The method of claim 3, wherein each of the individual reflector clusters corresponds to the scan information data having die distances whose difference is less than or equal to a distance threshold, and
the distance threshold is any one of width, height, or diameter of one of the laser reflectors.

5. The method of claim 4, wherein the determining whether each of the individual reflector clusters is a valid individual reflector cluster includes:
calculating an angular range of the laser beams corresponding to each of the individual reflector clusters based on an average value of the distances of the scan information data corresponding to each of the individual reflector clusters;
calculating an expected number of the scan information data included in each of the individual reflector clusters based on the angular range of the laser beams; and determining whether each of the individual reflector clusters is a valid individual reflector cluster based on the expected number of the scan information data.

6. The method of claim 5, wherein the angular range (Δ) of the laser beams is determined by the equation
$$Δ = 2 {sin}^{- 1} \frac{D}{2 {d}_{m}} ,$$
where D is a width or a diameter of the laser reflector, dₘ is the average value of distances.

7. The method of claim 5, wherein the expected number of the scan information data is determined by dividing the angular range of the laser beam by an angle resolution of the laser beam.

8. The method of claim 5, wherein tire determining whether each of the individual reflector clusters is a valid individual reflector cluster further includes,
calculating a difference between the expected number of the scan information data and a number of the scan information data included in each of tire individual reflector clusters; and
determining the individual reflector cluster as the valid individual reflector cluster if the difference is within an acceptable error number threshold.

9. The method of claim 1, wherein the position of the actual individual laser reflector is calculated based on the distance and the angle of the laser beam of at least one of the scan information data corresponding to the each of the valid individual reflector clusters.

10. The method of claim 9, wherein the position of the actual individual laser reflector is calculated in consideration of a radius of the actual individual laser reflector, when the actual individual laser reflector is circular.

11. An apparatus for collecting position information of laser reflectors for mobile robot localisation, comprising:
a processor for collecting scan information data corresponding to positions of surrounding objects using a laser scanner mounted on a mobile robot, generating a reflector cluster based on reflection intensities of the scan information data, classifying the reflector cluster into individual reflector clusters, each of the individual reflector clusters corresponding to each of the laser reflectors, determining whether each of the individual reflector clusters is a valid individual reflector cluster corresponding to an actual individual laser reflector or not based on geometric filtering on the each of the individual reflector clusters, and
memory for storing at least one of the scan information data, the reflector cluster, the individual reflector clusters and the valid individual reflector clusters.

12. The apparatus of claim 11, wherein the scan information datum includes a distance of a surrounding object, an angle of a laser beam and a reflection intensity of the laser beam.

13. The apparatus of claim 12, wherein the reflector cluster corresponds to the scan information data having the reflection intensities which are bigger than or equal to a reflection intensity threshold, and
the reflection intensity threshold is determined according to a type of one of the laser reflectors.

14. The apparatus of claim 13, wherein each of the individual reflector clusters corresponds to the scan information data having the distances whose difference is less than or equal to a distance threshold, and
the distance threshold is any one of width, height, or diameter of one of the laser reflectors.

15. The apparatus of claim 14, wherein the processor calculates an angular range of the laser beams corresponding to each of the individual reflector clusters based on an average value of the distances of the scan information data corresponding to each of the individual reflector clusters, calculates an expected number of the scan information data included in each of the individual reflector clusters based on the angular range of the laser beams, and determines whether each of the individual reflector clusters is a valid individual reflector cluster based on the expected number of the scan information data.

16. The apparatus of claim 15, wherein die angular range (Δ) of the laser beams is determined by the equation,
$$Δ = 2 {sin}^{- 1} \frac{D}{2 {d}_{m}} ,$$
where D is a width or a diameter of the laser reflector, dₘ is the average value of distances.

17. The apparatus of claim 15, wherein the expected number of the scan information data is determined by dividing the angular range of the laser beam by an angle resolution of the laser beam.

18. The apparatus of claim 15. wherein the processor calculates a difference between the expected number of the scan information data and a number of the scan information data included in each of the individual reflector clusters, and determines the individual reflector cluster as the valid individual reflector cluster if the difference is within an acceptable error number threshold.

19. An apparatus for calculating positions of laser reflectors for mobile robot localization, comprising.
a processor for receiving valid individual reflector clusters corresponding to actual individual laser reflectors from a position information collection apparatus, and calculating position of the actual individual laser reflector based on at least one of the scan information data corresponding to the each of the valid individual reflector clusters', and
memory for storing the positions of the actual individual laser reflectors.

20. The apparatus of claim 19, wherein the position of the actual individual laser reflector is calculated based on the distance and the angle of the laser beam of at least one of the scan information data corresponding to the each of the valid individual reflector clusters.
